(19) United States
(12) Patent Application Publication
(10) Pub. No.: US 2019/0216162 A1
(43) Pub. Date: Jul. 18, 2019

(54) FOOTWEAR APPARATUS FOR CONVERTING IMPACT FORCES TO ELECTRICAL POWER

(71) Applicant: Zero Point Energy Inc., Los Angeles, CA (US)

(72) Inventors: Jacob Yasha Gruben, New York, NY (US); Maral Kalinian, San Juan Capistrano, CA (US)

(73) Assignee: Zero Point Energy Inc., Los Angeles, CA (US)

(21) Appl. No.: 16/243,893

(22) Filed: Jan. 9, 2019

Related U.S. Application Data
(60) Provisional application No. 62/617,509, filed on Jan. 15, 2018.

(51) Int. Cl. A43B 3/00; A43B 13/14; H02N 2/18

(52) U.S. Cl. CPC A43B 3/0015; A43B 13/14; H02N 2/183; H02N 2/181; A43B 3/001

(57) ABSTRACT

A system has a database that stores a plurality of audio/visual clips. Further, the system has a memory device that has a buffer with a threshold quantity of memory blocks. In addition, the system has a processor that receives the plurality of audio/visual clips in an ordered sequence for a virtual sports game. The processor also writes one or more frames of a first audio/visual clip to the buffer. Further, the processor allocates the threshold quantity of memory blocks such that the processing speed of writing one or more frames of a second audio/visual clip to the buffer is faster than a broadcast frame rate for broadcasting the first audio/visual clip. In addition, the processor writes the one or more frames of the second audio/visual clip to the allocated threshold quantity of memory blocks of the buffer.

### RELATED APPLICATIONS

This patent application claims priority to U.S. Provisional Patent Application Ser. No. 62/617,509, filed on Jan. 15, 2018, which is hereby incorporated by reference in its entirety.

### BACKGROUND

### 1. Field

This disclosure generally relates to footwear. More particularly, the disclosure relates to converting forces to electrical power via a footwear apparatus.

### 2. General Background

Clean and sustainable sources of energy are typically utilized to supply energy, while also helping to protect the environment. Examples of conventional sources of clean energy are solar power, wind power, etc. Yet, such conventional sources of clean energy are typically not sufficient enough, by themselves, to supply enough energy to mass-populated geographic areas. As a result, non-clean energy sources are often additionally necessary.

### SUMMARY

In one embodiment, an apparatus has a shoe. Further, the apparatus has a support structure positioned within the shoe. Additionally, the apparatus has a rechargeable power supply that is operably attached to the support structure. Further, the apparatus has a force-to-energy conversion device that is operably attached to the support structure. The force-to-energy conversion device receives one or more external forces from an environment external to the shoe. Further, the force-to-energy conversion device converts the one or more external forces to electrical energy. Moreover, the force-to-energy conversion device transfers the electrical energy to the rechargeable power supply for storage in the rechargeable power supply.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a system that is used to convert the force generated by the impact of a shoe with a surface, such as the ground.

FIG. 2 illustrates a piezoelectric assembly that includes componentry for converting forces to electrical energy.

FIG. 3 illustrates an electronics assembly positioned within the shoe.

FIG. 4 illustrates a removable battery compartment that may be removed from the shoe.

### DETAILED DESCRIPTION

A system is provided to convert various types of forces (e.g., mechanical) generated via footwear (e.g., shoes) into electrical power. As opposed to conventional configurations that allow various forms of clean energy to be untapped, the system allows for harvesting energy by converting mechanical forces into electrical power. Such energy may then be used to power devices positioned within the footwear, or even devices positioned externally to the footwear. For example, one or more cables may be connected to the footwear and an electronic device (e.g., smartphone) to provide electrical power to the electronics device. As another example, the electrical power that is generated via the footwear may be stored in a removable power supply that is inserted into the electronics device to provide electrical power to the electronics device.

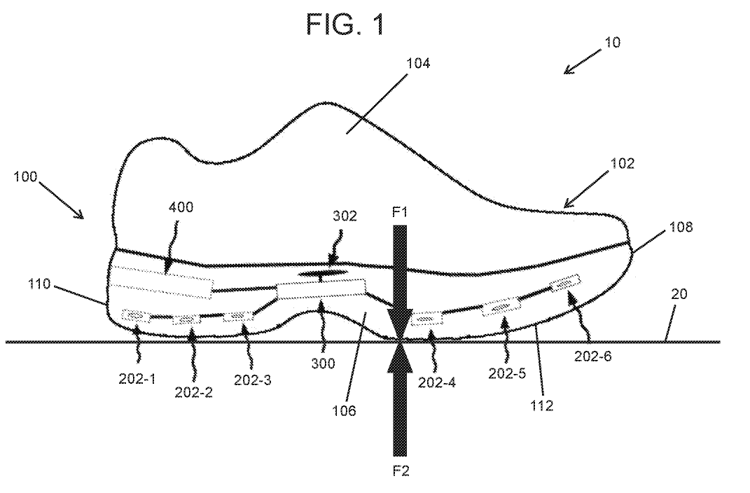

FIG. 1 illustrates a system 10 that is used to convert the force generated by the impact of a shoe 102 with a surface, such as the ground. As an example, the system 10 allows for converting the mechanical forces exerted by a user that is walking into electrical power.

The system 10 may include a support assembly 100, an electronics assembly 300, and a power storage assembly 400. The system 10 may also include other components, elements, assemblies, and mechanisms.

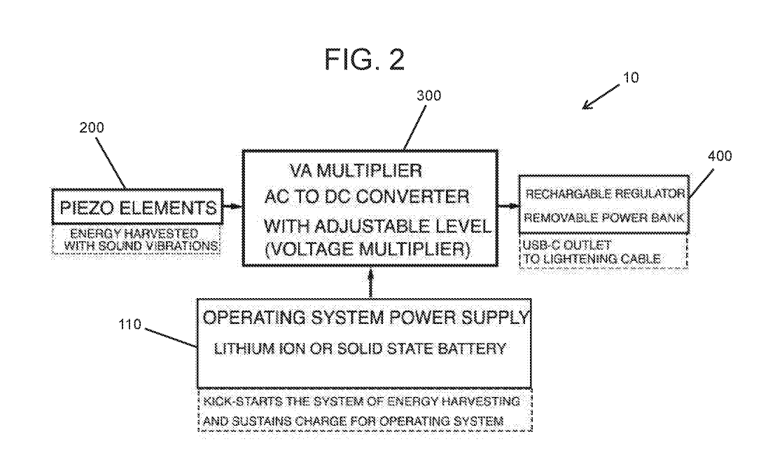

The support assembly 100 may position, secure, and support the overall structure of the system 10, including its various assemblies, components, elements and mechanisms. For example, the support structure 100 may support and position the components, elements and mechanisms of a piezoelectric assembly 200, as illustrated in FIG. 2, such that the piezoelectric assembly 200 may receive the forces to be converted into electrical power. The support assembly 100 may also support and position the electronics assembly 300 and the power storage assembly 400 such that these assemblies may perform their respective functionalities with respect to the other assemblies within the system 10. The support structure 100 may also support and position other components and elements of the system 10.

The piezoelectric assembly 200 illustrated in FIG. 2 may comprise one or more piezoelectric elements 202-1, 202-2, 202-3 . . . 202-n (collectively and individually 202), which are illustrated in FIG. 1, that may convert mechanical forces to electrical power. The power output of each particular piezoelectric element 202 may depend upon intrinsic and extrinsic factors. Intrinsic factors may include the frequency constant and resonant frequency of each piezoelectric element 202, as well as the piezoelectric and mechanical properties of the material used in addition to other factors. Extrinsic factors may include the applied force vibration frequency, the magnitude of the force, acceleration of the base/host structure, the amplitude of the excitation as well as other factors.

The piezoelectric effect may be found in crystalline materials that possess non-centrosymmetry. This effect induces an electric polarization proportional to an applied mechanical stress to the piezoelectric material. A shifting of the positive and negative charge centers within the piezoelectric material may take place when the material is placed under stress resulting in an external electrical field. In this way, the piezoelectric materials may convert mechanical strain into an electrical charge or voltage via the direct piezoelectric effect.

The piezoelectric elements 202 may include a variety of different architectures, features, and capabilities. For example, the piezoelectric elements 202 may include piezo bending generators mounted as cantilevers or simple beams, zig-zag cantilevers, unimorph/bimorph cantilevers, cymbals, stacks, plates or any other types or combinations of piezoelectric elements thereof. Some examples of piezoelectric materials may include quartz, berlinite, sucrose, Rochelle salt, topaz, tourmaline-group lead titanate, and other materials. In addition, man-made materials such as PZT (also known as lead zirconate titanate), barium titanate, and lithium niobate may have a more pronounced piezoelectric effect than quartz and other natural piezoelectric materials. Each type of piezoelectric element 202 may include a different frequency operating range and power output depending on its mechanical architecture and material properties.

As an example of how a piezoelectric element 202 may function, vibrational waves (e.g., sound or mechanical) may strike one or both sides of a piezoelectric element 202 causing the piezoelectric element 202 to vibrate. The piezo material of the piezoelectric element 202 may pick up this vibration and translate it into a series of electric charges as described above. The electric charges may exhibit a waveform similar to the vibrational input waveform of the exerted force, and may accordingly produce an alternating current (“AC”) waveform that may be similar to the vibrational waveform.

In one embodiment, the AC current is converted to a direct current (“DC”), which is then amplified so that the power may be used to charge a power supply such as a battery. Accordingly, the electrical charges generated by the piezoelectric assembly 200 may then be fed into the electronics assembly 300 where the power may be amplified, multiplied, rectified, filtered and otherwise conditioned. The resulting power may then be stored in the power storage assembly 400 to be used for powering devices within the shoe 102, or external to the shoe 102.

In the example depicted in FIG. 1, the mechanical forces applied to the shoe 102 (e.g., sneaker, boot, sandal, sock, slipper, etc.) may be converted into electrical power during activities performed while a user wears the shoe 102 (e.g., the act of walking, running, or otherwise wearing the shoe). In one embodiment, the support assembly 100 is the shoe 102, which may comprise an upper portion 104 and a sole portion 106. The shoe 102, and particularly the sole 106, may include a front 108, a back 110 and a bottom 112. The upper portion 104 may include the body of the shoe 102, which receives the foot of the user. In another embodiment, the support assembly 100 is positioned, or is integrated, within the shoe 102. For example, the support assembly 100 may be the sole 106.

As examples, the forces may be in the form of physical vibrations, sound vibrations, mechanical displacements, kinetic, pressure, compression, mechanical stress, mechanical impact, shock, and/or other types of or combinations of forces. The system 10 generates and stores an electrical charge when such forces are applied to the one or more piezoelectric elements 202 (i.e., when stressed, compressed, displaced or otherwise physically acted upon).

The sole 106 of the shoe 102 may be configured with the upper portion 104 of the shoe 102 such that the sole 106 may come into physical contact with ground 20 or outer environment surrounding the shoe 102. The sole 106 of the shoe 102 may be configured with the upper portion 104 in a way that adequately attaches and/or secures, the sole 106 to the upper 104 so that it may remain attached during activities performed with the shoe 102.

The sole 106 may include materials such as leather, resin rubber, crepe rubber, vulcanized rubber, solid PVC, blown PVC, polyurethane, rope, TPR, EVA or other materials that allow the sole 106 to be flexible so that it may adequately flex during the motion of walking or running. In addition, the sole 106 may be adequately soft (e.g., via a cushion) so that the shoe 102 may be comfortable to wear and use, but rugged enough to withstand the forces and wear that it may experience.

During the act of walking, running, dancing or other types of motions, the sole 106 of the shoe 102 may repeatedly come into direct contact with the ground 20, and possibly with a significant impact. When the sole 106 travels downward during such motion and impacts the ground with a substantially downward force F1, an equal and substantially upward force F2 result and be exerted onto the sole 106. The force F2 may be exerted upward into the bottom 112 of the sole 106 such that the force may travel through the sole 106 material.

Accordingly, the piezoelectric elements 202 may be configured with the sole 106 of the shoe 102 as the sole 106 may receive the majority of the forces that may be applied to the shoe 102 during walking, running, etc. In addition, the piezoelectric elements 202 may be configured, positioned, located, and oriented with the shoe 102 in such a way to maximize the forces that the piezoelectric elements 202 may receive during the motion of walking, running, etc. In this way, the piezoelectric elements 202 may absorb the forces and convert the forces to electric charges.

The piezoelectric elements 202 may be embedded in the sole 106 as shown in FIG. 1. The piezoelectric elements 202 may be co-molded within the sole 106, or embedded or placed into the sole 106, after the sole 106 has been fabricated. The sole 106 may also comprise a material and structure that may transmit the forces (e.g., vibrations, impacts, deflections, compression, pressure, shock, etc.) that may be imposed upon the sole 106 directly to piezoelectric elements 202 that may be configured with the shoe 102 (e.g., via with the sole 106).

As illustrated in FIG. 1, the piezoelectric elements 202 may be configured within the sole 106 in areas of the sole 106 (e.g., toward the back 110, toward the front 108, and in-between the front 108 and the rear 110 such as in the middle) that may receive impact during activities such as walking. However, the piezoelectric elements 202 may be positioned anywhere within the sole 106 or the shoe 102 that may allow the piezoelectric elements 202 to receive forces to convert to electrical charges. While FIG. 1 depicts six piezoelectric elements 202 configured within the sole 106, other numbers of piezoelectric elements 202 may be used instead.

The piezoelectric elements 202 may be connected in series (as depicted in FIG. 1), in parallel, or in any combination thereof.

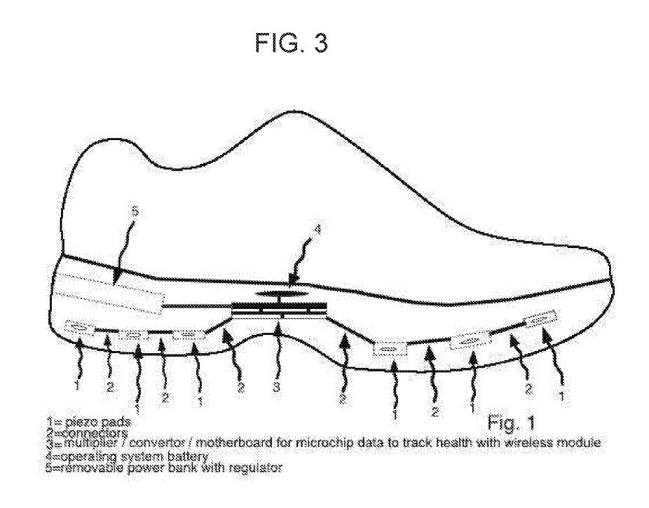

Further, the electronics assembly 300 (FIG. 3) may also be configured within the shoe 202 (e.g., within the sole 106 or the upper body 104 of the sole 106). While FIG. 1 depicts the electronics assembly 300 configured within the sole 106 of the shoe 102, the assembly 300 may be configured in any area of the shoe 102, or in any combination of areas of the shoe 102.

The electronics assembly 300 may electronics, circuitry, electrical components and devices, control boards, processors, microprocessors, microcontrollers, amplifiers, multipliers, rectifiers, filters, memory, power transformers, impedance matching networks and other types of electrical and non-electrical components and devices that power, control, maintain and generally operate the system 10.

For example, the electronics assembly 300 may include an AC to DC converter (e.g., a diode bridge) that may be used to convert the AC charges generated by the piezoelectric elements 202 to usable DC that may be used to charge power storage assembly 400 as well as other components of the system 10. In addition, the electronics assembly 300 may include one or more power amplifiers or multipliers that may amplify the power levels generated by the elements 202 to higher power levels to be stored in the power storage assembly 400. The gain or level of the amplifiers and/or the multipliers may be adjustable, or the gain and levels may be fixed, or any combination thereof.

As other examples, the electronics assembly 300 may include a voltage multiplier that may convert the AC electrical power generated by the elements 202 from a lower voltage to a higher DC voltage. A voltage multiplier may use a network of capacitors and diodes, or other types of components. In this way, the charges may be rectified and amplified by the multiplier(s). For example, the electronics assembly 300 may include a half-wave series multiplier or other type of multiplier.

The electronics assembly 300 may also include one or more transformers that may adjust the voltage of the electrical charge to a voltage that may be used by the other components such as the rechargeable battery 400 and/or the operating system battery 302. The various components, elements, sections, segments, blocks or portions of the electronics assembly 300 may be configured in a variety of locations, positions and configurations with respect to the shoe 102 and the sole 206.

Electronics assembly 300 may also include the processors, microprocessors, microcontrollers, control boards, or other types of controllers that control and operate the components of system 10. The electronics assembly 300 may also include software programs, drivers and applications that may be used to control the various components and devices that may be included and/or used in conjunction with system 10. In this way, the electronics assembly 300 may also be a controller that may control the various functions and systems of the system 10. The above list of components and devices that may be used with or in conjunction with system 10 does not limit the scope of system 10 or the components or devices that system 10 may include or work in conjunction with. Other components and devices may also be included.

As depicted in FIGS. 1 and 2, the system 10 may also include an operating system power source 302 (e.g., a lithium ion, solid state, or other type of battery) that may be used to power the electronics assembly 300. The power source 302 may be charged (continually or periodically) by the electrical power generated by the piezoelectric assembly 200 (converted to DC) or by other sources. If the power source 302 is charged by other sources, the electronics assembly 300 may include an external port/jack/outlet (e.g., mini-USB) that may be accessible from outside the shoe 102 such that an outside power source may be plugged into the electronics assembly 300 to apply a charge to the operating system power source 302 for recharging. The power source 302 may also be charged by inductive charging or other charging methods.

The system 10 may have several modes of operation such as an On Mode, an Off Mode, a Sleep mode, and other modes. The On mode may include the system 10 being turned on and active, with the piezoelectric elements 202 ready to receive forces to convert to electrical charges and the electronics assembly 300 being on and ready to condition the generated AC power and control the system 10. The Off mode may turn all of the electrical components of the system 10 off. The Sleep mode may allow the system 10 to sleep or hibernate while the shoes may be at rest (not being used). In this mode, the system 10 may include a trigger switch (e.g., one or more of the piezoelectric elements 202 may be wired to activate the system 10 upon sensing movement or impacts) that may bring the system 10 out of sleep mode and into an active mode when the user may begin to use the shoes 102. Once this happens, the system 10 may be fully operational. Then, when the shoes 102 may be removed or otherwise be at rest again (e.g., for a predefined amount of time), the system 10 may return to hibernation (sleep) mode in order to conserve the power charge of its battery 302. In this mode, the system 10 may await another trigger to become operational again.

The system 10 may also include a power storage assembly 400 that may store the electrical energy generated by the piezoelectric assembly 200. For example, the power storage assembly 400 may include one or more rechargeable batteries such as Nickel Cadmium (NiCd) batteries, Nickel-Metal Hydride (NiMH) batteries, Lead Acid batteries, Lithium Ion batteries, Lithium Polymer batteries or other types of rechargeable batteries. Other types of rechargeable power supplies may also be used such as capacitors, inductors, or any type of rechargeable power storage device or component or any combination thereof. The type(s) of rechargeable power storage assemblies that the system 10 may use in no way limits the scope of the system 10.

In another example, the system 10 may collect or harvest the electrical charges generated by the piezoelectric assembly 200 and store the energy in an on-board capacitor bank. The capacitor bank may be continually monitored by the electronics assembly 300 such that when the capacitor bank may reach a particular level of stored voltage, it may be enabled to release the stored voltage to a rechargeable battery as described above to charge the battery. The process may then repeat with the recharging of the capacitor bank and the transfer of the energy to the rechargeable battery 400. In another example, the electronics assembly 300 may direct the amplified/rectified electrical power directly to the rechargeable battery 400 without the use of an intermediate capacitor bank. Alternatively, the system 10 may use a combination of the examples described, or any other type of protocol to generally direct and apply the power generated by the piezoelectric assembly 200 to the rechargeable power source assembly 400 for energy storage.

The power storage assembly 400 may be removably configured with the shoe 102 so that once charged the removable battery 400 may be removed from the shoe 102 and used to power other external devices or transferred to other power sources such as other rechargeable batteries. The rechargeable power storage unit 400 may also be used to power devices or components of the system 10 (e.g., lights that may be on the shoe 102, the operating system power supply 302 and other types of local devices). In one embodiment, the power storage assembly 400 may be easily removed from the system 10 (e.g. from the shoe 102) and easily replaced back to the shoe 102 as necessary. The rechargeable power storage assembly 400 may also be configured with the shoe 102 so that it may be secure and protected from potential damage.

In addition, the power storage assembly 400 may include external jacks/outlets so that the assembly 400 may be connected directly to an external rechargeable power source that may be charged by the power storage assembly 400 upon being connected. In this way, the rechargeable power storage assembly 400 may or may not need to be removed; however, any combination of procedures described above may be implemented.

The system 10 may include all of the wiring and cabling between all of the electronics, electrical components, devices or other elements in order to provide power to all of the aforementioned, to control all of the aforementioned, and to maintain and operate all of the aforementioned. In this way, the system 10 comprises a fully integrated and fully functioning system and framework of interconnected controllers, devices and components.

In addition, the system 10 may include a mechanism or application that may be installed on a mobile device such as a smartphone, tablet computer or other type of device. The application may allow the user to interface with the system 10 in order to initiate its setup, initialize the system 10, test the system 10 performance, confirm its configuration, set its parameters, configure its different settings, troubleshoot any problems, register the product and the user information, as well as other functionalities. In one example, the application 500 may show the power generated by the system 10 over the course of a particular period of time. In another example, the application may assist the user to troubleshoot the system 10 by providing a troubleshooting wizard or guidelines. In yet another example, the application may allow the user to disable the system 10 when the user may not wish to utilize the system 10, and then to re-enable the system 10 when ifs functionality is again desired. The examples of the application's functionalities are provided to illustrate possible functionalities, and are not intended to limit the scope of the application.

Various communication protocols (e.g., wireless) may be used for the system 10 to communicate with the application and the device that uses the application. In addition, the system 10 may be connected to the digital device and the application via cables or transmission lines (e.g., USB-C, lightening cable, etc.).

In operation, a user may obtain one or preferably a pair of shoes 102 and place them on his/her feet. The user may turn the system 10 On, or the system 10 may automatically turn On when it senses that the shoes 102 may be in use. As the user of the shoes 102 walks, runs, dances, or otherwise uses the shoes 102, the shoes 104 may make impact with the ground 20 and the applied forces to the soles 106 of the shoes 102 due to the impact may be exerted onto the piezoelectric elements 202 and converted to electric charges. The electric charges may then be amplified, rectified, filtered (e.g., to reduce noise), and otherwise conditioned by the electronics assembly 300 and stored at the power storage assembly 400. The stored energy within the power storage assembly 400 may then be used to power other devices or may be stored to other rechargeable power supplies. The user may view the app on his or her mobile device that may be paired with the system 10 using one or more pairing protocols to view the amount of energy stored and other characteristics of the system 10.

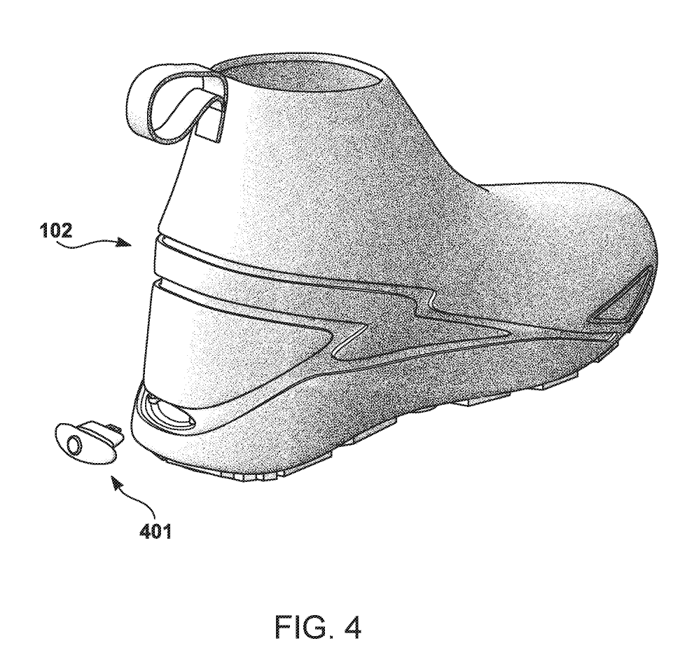

Further, FIG. 4 illustrates a removable battery 401 that may be removed from the shoe 102.

It is understood that the systems and apparatuses described herein may also be applied in other types of apparatuses. Those skilled in the art will appreciate that the various adaptations and modifications of the embodiments of the systems and apparatuses described herein may be configured without departing from the scope and spirit of the present systems and apparatuses. Therefore, it is to be understood that, within the scope of the appended claims, the present systems and apparatuses may be practiced other than as specifically described herein.

We claim:

1. A system comprising:
a shoe;
a support structure positioned within the shoe;
a rechargeable power supply that is attached to, and removable from, the support structure; and
a force-to-energy conversion device that is operably attached to the support structure, the force-to-energy conversion device receiving one or more external forces from an environment external to the shoe, the force-to-energy conversion device converting the one or more external forces to electrical energy, the force-to-energy conversion device transferring the electrical energy to the rechargeable power supply for storage in the rechargeable power supply.

2. The system of claim 1, wherein the force-to-energy conversion device comprises one or more piezoelectric elements.

3. The system of claim 1, wherein the one or more external forces comprises a force generated by impact between the shoe and a surface.

4. The system of claim 1, wherein the rechargeable power supply is a rechargeable battery.

5. The system of claim 1, wherein the rechargeable power supply is removable from the support structure for providing electrical energy to a device that is external to the shoe.

6. The system of claim 1, further comprising one or more external outlets that are operably connected to the rechargeable power supply positioned within the support structure, the rechargeable power supply providing electrical energy to a device that is external to the shoe via one or more cables that connect the rechargeable power supply to the device.

7. The system of claim 1, wherein the rechargeable power supply provides power to one or more components operably attached to the support structure.

8. The system of claim 1, further comprising one or more lights that are operably attached to the support structure, the one or more lights being powered by the rechargeable power supply.

9. The system of claim 1, further comprising a processor that wirelessly communicates with an application stored on a smartphone.

10. The system of claim 9, wherein the application displays, on the smartphone, an amount of electrical energy stored by the rechargeable power supply.
